(19) United States
(12) Patent Application Publication
(10) Pub. No.: US 2009/0045648 A1
(43) Pub. Date: Feb. 19, 2009

(54) Protective device with a flexible protective canopy

(76) Inventors: Markus Hintennach, Reichenbach (DE); Zoltan Papp, Halaeszi (HU); Ephraim Moeser, Borken (DE); Guenther Renz, Ditzingen (DE)

Correspondence Address: FLYNN THIEL BOUTELL & TANIS, P.C., 2026 RAMBLING ROAD, KALAMAZOO, MI, 49008-1631, US

(21) Appl. No.: 12/220,690

(22) Filed: Jul. 25, 2008

(30) Foreign Application Priority Data
Jul. 25, 2007 (DE) 10 2007 036 652.5

(51) Int. Cl. B62D 25/06

(52) U.S. Cl. 296/136.12

(57) ABSTRACT

A protective device with a flexible protective canopy, having a winding shaft, on which the protective canopy is held so that it can be wound and unwound, and a mounting in which the winding shaft is rotatably supported is known, the mounting with its opposing lateral areas being guided so that it is longitudinally displaceable, and the protective canopy having a leading edge face which is immovably secured.

According to the invention, over the displacement length of the mounting, at least, the opposite lateral areas each have a flexible cover profile assigned to them, which immovably extends parallel to the guides and projects transversely to the direction of displacement towards the middle of the protective canopy, in such a way that the cover profile at least partially covers a corresponding lateral edge of the protective canopy and the corresponding lateral area of the mounting.

Use as sunshade for passenger cars.

The invention relates to a protective device with a flexible protective canopy, having a winding shaft, on which the protective canopy is held so that it can be wound and unwound, and a mounting in which the winding shaft is rotatably supported, the mounting with its opposite lateral areas being guided so that it is longitudinally displaceable in immovable guides in the winding and unwinding direction of the protective canopy, and the protective canopy in the unwinding direction having a leading edge face which is immovably secured at least in a partially unwound state of the protective canopy.

Such a protective device is commonly known as a sunshade. The protective device has a flexible protective canopy, which with one end face is held on a winding shaft, which is rotatably supported in a housing. The other, free end of the protective canopy is immovably fixed. The housing serving as mounting for the winding shaft is guided by its opposite lateral areas so that it is longitudinally displaceable in guide rails. Under a displacement of the housing, the protective canopy, immovably secured at its one end face, is forcibly wound off or onto the winding shaft. For this purpose a return spring, which applies a torque biasing the winding shaft in the winding direction, is assigned to the winding shaft. A gap, where the protective device affords no protection against sunlight, remains between the opposite lateral edges of the protective canopy and the guide rails serving to guide the housing.

The object of the invention is to create a protective device of the type specified in the introduction, which affords an improved protection.

This object is achieved in that over the displacement length of the mounting, at least, the opposite lateral areas each have a flexible cover profile assigned to them, which immovably extends parallel to the guides and projects transversely to the direction of displacement towards the middle of the protective canopy, in such a way that the cover profile at least partially covers a corresponding lateral edge of the protective canopy and the corresponding lateral area of the mounting. The flexibility of the cover profile permits adjustment and allows the cover profile to yield momentarily in the vicinity of whatever position the lateral area of the mounting has assumed at any given instant, so that the corresponding cover is maintained even during a displacement of the mounting. The solution according to the invention is especially advantageous in allowing the protective device to be used in motor vehicles, and particularly as a sun protection or light protection for vehicle windows or glass roofs, and as a load space protective device, in order either to cover a load space horizontally or to permit an approximately vertical separation of a load space from a passenger compartment. Each cover profile may be of single or multipart design. For the function according to the invention it is sufficient for the respective cover profile to be assigned to the corresponding lateral area of the mounting and to the respective lateral edge of the protective canopy in the area of an outside, or an inside or an upper side or an underside. It is also possible, however, to design the cover profile so as to provide coverage from both sides, that is to say both from the outside and from the inside, or both from the upper side and from the underside. The mounting with its lateral areas may be embodied as a closed housing, in particular as a cassette housing, or as an open mounting with preferably cupped, dimensionally stable lateral areas and a rigid cross connection between the lateral areas.

In a development of the invention, clips for immovable fixing of the protective canopy, which are of detachable design for an at least momentary release of the edge face or the lateral edges, are assigned to the leading edge face of the protective canopy and/or to the lateral edges of the protective canopy. The clips may serve, on the one hand, for fixing the leading edge face of the protective canopy during a displacement of the mounting and hence during winding or unwinding of the protective canopy. In addition or alternatively, the clips serve to keep the protective canopy taut when it is in a partially or fully extended state by frictionally fixing the corresponding lateral edges of the protective canopy.

In a further development of the invention the clips are spatially associated with the cover profile. The clip function and the covering function may be integrated in one common profile.

In a further development of the invention at least one flexible cover profile is integrated in a double-lip profile in each case extending along an immovable guide, the two lip members of which profile grip over the upper side and underside of the lateral area of the mounting and the associated lateral edge of the protective canopy, both lip members being of elastically pliable design. The wording upper side and underside may—as already previously stated, be replaced by outside and inside, depending on whether the protective device is arranged in the area of a boundary of a vehicle interior such as a vehicle window or a glass roof, or more or less centrally in the vehicle interior, as is the case with a load space cover or a load space partition. Similarly, the term “front and rear” may also be used if such a wording will make the arrangement inside the vehicle interior more readily comprehensible for the person skilled in the art.

The elastic pliability of the lip members allows them to adjust to a corresponding displacement of the mounting in that the lip members will expand elastically when level with the momentary position of the corresponding lateral area of the mounting and will correspondingly close again once the mounting has moved on in one or the other direction.

The double-lip profile is preferably embodied as a hollow elastomer profile, which besides the two lip members is provided with an integrally molded fixing profile, which is immovably secured. The double-lip profile is preferably of one-piece design. The hollow profile is preferably of open design, at least in the area of the lip members, so that the lip members are not interlocked or materially fused together. The fixing profile allows the double-lip profile to be immovably fixed. In a preferred embodiment the fixing profile is held in a groove of a guide rail profile, which serves as a guide for the longitudinal displacement of the mounting and which is fixed to the vehicle and thereby immovably secured. The integral formation of the double-lip profile makes it easy and inexpensive to manufacture. The use of an elastomer material ensures the necessary flexibility and the desired elastic recovery of the lip members.

In a further development of the invention the two lip members of the double-lip profile run parallel to the guide for the associated lateral area of the mounting and are elastically flexible, in such a way that they are capable of expanding around a housing section of the lateral area of the mounting and conform to the housing section, at least with linear contact. The lip members therefore each open in the area in which the corresponding lateral area of the mounting is situated at any given time. Instead of a linear contact, the wording ‘at least with linear contact’ also encompasses an areal contact. The essential feature is the covering function, without the conformity generating any great frictional resistance that prevents the free-running displacement of the mounting.

In a further development of the invention the lip members are pressed against one another in an unstressed rest position, and with a lateral edge of the protective canopy inserted between them exert a force closure on the lateral edge such that a gripping action and in particular a restraining function is exerted on the lateral edge, countering any movement inwards transversely to the extending direction. Since a double-lip profile is provided on both sides of the mounting and thereby also on both sides of the protective canopy, both lateral edges of the protective canopy are gripped, so that any sagging or puckering of the protective canopy in the extended state is prevented. The protective canopy may advantageously contract in a transverse direction, especially under larger temperature fluctuations, without the protective canopy being damaged, since it is laterally held not by positive interlock but merely by force closure. The gripping force of the lip members is limited so that the lateral edges of the protective canopy can slide in a transverse direction in the event of corresponding contraction. Gripping of the lateral edges of the protective canopy means that the protective canopy could form a retaining function for objects sinking into the protective canopy, particularly if the protective canopy is used as a vertically tautened divider between a load space and a passenger compartment. The lip members therefore form clips within the terms of the invention, the clipping function securing the lateral edges both in a longitudinal direction and in a transverse direction.

In a further development of the invention the mounting for the winding shaft comprises a housing into which the housing sections at the lateral areas are integrated and which, viewed in cross section, is tapered on both sides in the manner of a wedge. The tapered areas of the housing exert a wedging action on the lip members of the double-lip profile, the one taper being responsible for the wedging action in one direction of longitudinal displacement and the other taper being responsible for the wedging action in the opposite direction of longitudinal displacement.

Further advantages and features of the invention are set forth in the claims and in the following description of preferred embodiments of the invention, which are represented in the drawing.

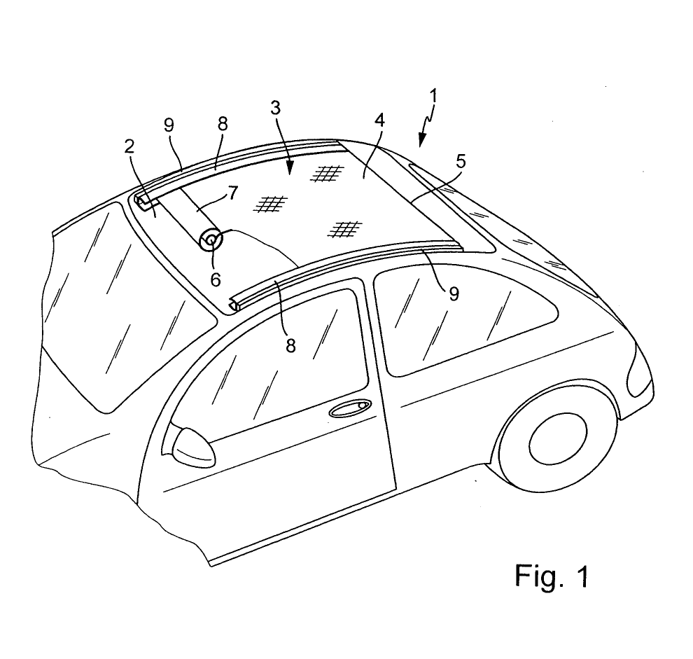

FIG. 1. schematically shows an embodiment of a protective device according to the invention in a glass roof area of a motor vehicle,

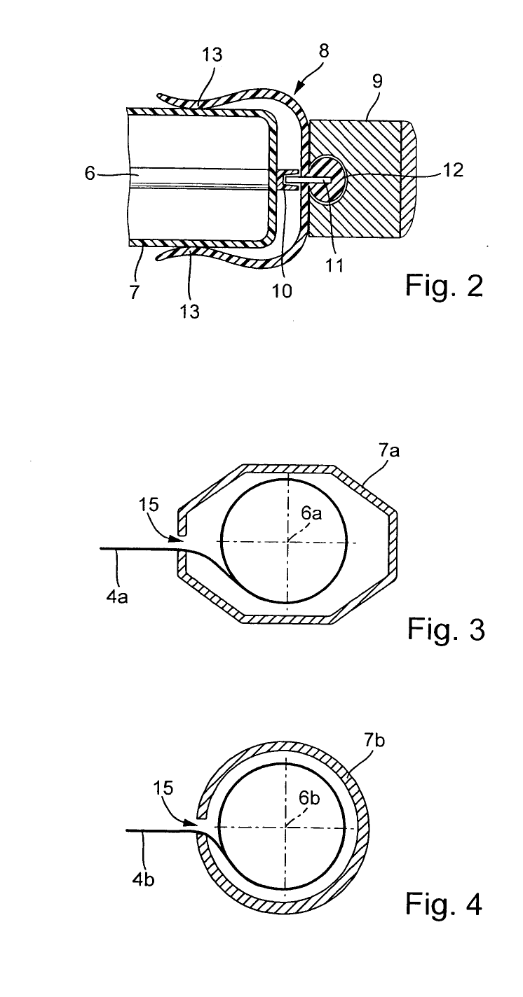

FIG. 2. shows a schematic sectional representation of a part of the protective device in FIG. 1,

FIG. 3. shows a housing for a winding shaft of a protective device similar to FIGS. 1 and 2,

FIG. 4. shows a further housing of a protective device similar to FIG. 3,

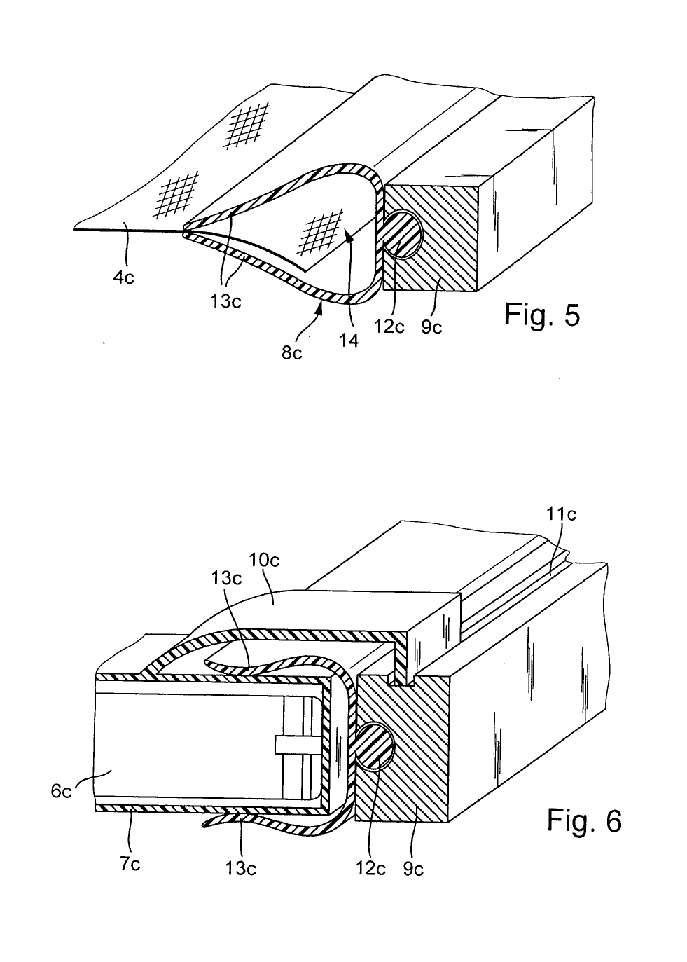

FIG. 5. schematically shows a partial area of a further embodiment of a protective device according to the invention in the gripping area of the lateral edges of a protective canopy,

FIG. 6. shows the protective device according to FIG. 5 in the area of a housing for accommodating a winding shaft for the protective canopy shown in FIG. 5,

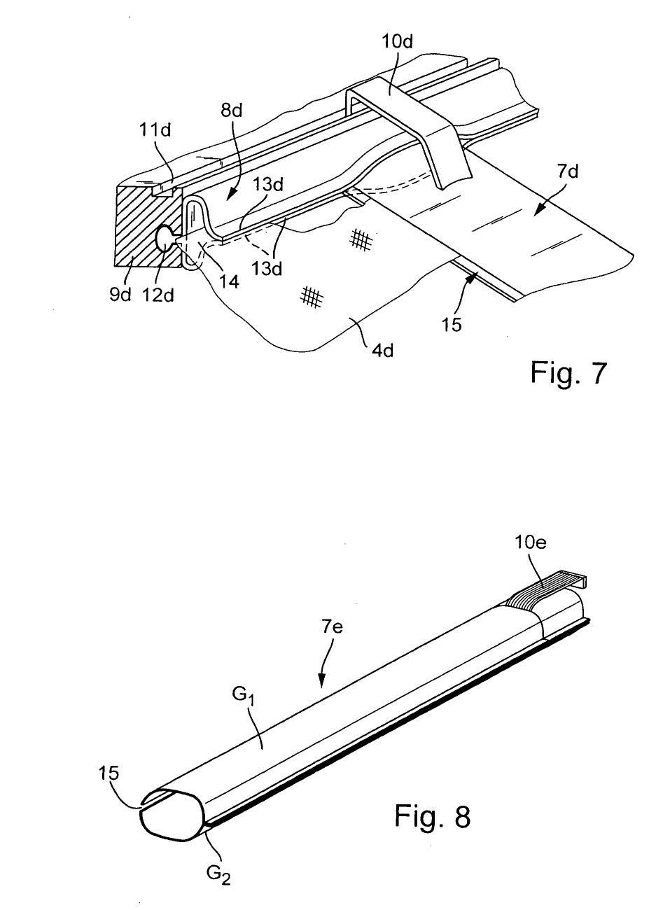

FIG. 7. shows a further embodiment of a protective device according to the invention similar to FIGS. 5 and 6 and

FIG. 8. shows a housing for a further embodiment of a protective device according to the invention similar to FIG. 3.

In a roof area a motor vehicle in the form of a passenger car 1 according to FIG. 1 has a roof opening, which is closed by a glass roof 2. In order to afford vehicle occupants some protection from the sun, the glass roof 2 notwithstanding, a protective device 3 is provided, which is arranged in the vehicle interior below and approximately parallel with the glass roof 2.

As is represented schematically in FIG. 2, the protective device 3 in the area of opposite lateral roof frames of a body support structure of the motor vehicle 1 has two guide profiles 9, which are fixed to the lateral roof frames and are thereby arranged so that they cannot move in relation to the motor vehicle 1. The guide profiles 9 extend at least substantially over the length of the glass roof 2 in the vehicle longitudinal direction, the opposite guide profiles 9 being aligned parallel with one another. Extending between the guide profiles 9 in the vehicle transverse direction and thereby transversely to the longitudinal extent of the guide profiles 9 is a cassette housing 7, which serves as mounting for a winding shaft 6, which is rotatably supported in the cassette housing 7. A flexible sheet in the form of a protective canopy is held on the winding shaft 6 so that it can be wound and unwound. The length of the protective canopy—viewed in the vehicle longitudinal direction—is at least largely equal to the length of the glass roof area to be covered. The width of the protective canopy 4 is somewhat less than the distance between the guide profiles 9. An end face area of the protective canopy 4 is basically fixed to the winding shaft 6 in a known manner. The leading end face area 5 in the direction of unwinding and hence the end face area opposite to the first mentioned end face area is provided at the free end face of the protective canopy 4. It may be provided with a dimensionally stable profiled strip, which extends over the entire width of the protective canopy 4 and is immovably held at the end areas of the guide profiles 9. In the embodiment shown in FIG. 1, the end face area 5 therefore forms the rear end of the protective device 3.

In the exemplary embodiment shown, the end face area 5, as can be seen from FIG. 1, is not provided with an additional dimensionally stable profiled strip.

The cassette housing 7 can be displaced along the guide profiles 9 by means of a guide rail arrangement 10, 11 (FIG. 2). In the exemplary embodiment shown, the cassette housing 7 is displaced manually by an appropriate operator from the vehicle interior. Since the end face area 5 of the protective canopy 4 and other areal sections of the protective canopy 4—as is further described below—are immovably fixed between the guide profiles 9, the protective canopy 4 is forcibly unwound from the winding shaft 6 as the cassette housing 7 is displaced forwards in the longitudinal direction of the vehicle, and the protective canopy 4 is accordingly drawn out of the cassette housing 7. For this purpose a corresponding exit slot 15 is provided in the cassette housing 7 (FIGS. 3, 4, 7, 8). The winding shaft 6 is furthermore provided—in a manner not further shown—with a return spring arrangement, which applies a limited torque to the winding shaft 6 in the winding direction. The return spring is designed with a relative weak return force, so as not to overcome corresponding self-locking functions of the cassette housing 7 or the extended protective canopy 4, thus causing an unintentional displacement of the cassette housing 7 or an unintentional winding of the protective canopy 4.

In the embodiment according to FIG. 2, the longitudinal displacement of the cassette housing 7 at the opposite lateral areas of the cassette housing 7 is in each case achieved by a guide, which is formed on the one hand by a guide web 11, extending approximately horizontally and radially inwards, and on the other by a slide 10 arranged on the end face of the cassette housing 7. The guide web 11 is embedded in a fixing profile section 12 at approximately half the height of the guide profile, said profile section in turn forming part of a double-lip profile 8 described in more detail below. The guide web 11 extends over the entire guide length of the guide profile 9 and is immovably held in a corresponding channel of the guide profile 9 by means of the fixing profile section 12. The channel of each guide profile 9 is open inwards towards the middle of the vehicle.

In the embodiments according to FIGS. 5 to 8, other guide means have been selected for guiding the respective cassette housing 7c to 7e. There too, a guide profile 9c, 9d, which is immovably fixed inside the motor vehicle, is assigned to each of the opposite end faces of the cassette housing 7c to 7e. In their basic arrangement and function the embodiments correspond to the embodiment in FIG. 1, so that in order to avoid repetition, reference will be made to the description of FIG. 1. In the embodiments according to FIGS. 5 to 8 the cassette housing 7c to 7e is not guided by corresponding guide members, which are arranged approximately level with an axis of rotation of the winding shaft, as is the case in the embodiment according to FIG. 2, but by means of two cantilever arms 10c to 10e, which project upwards from an upper side of the cassette housing 7c to 7e and laterally outwards beyond the assigned end face of the cassette housing 7c to 7e. A cantilever arm 10c to 10e is provided on each of the opposite side faces of the cassette housing 7c to 7e. Each cantilever arm has a downward-projecting slide web, which is longitudinally displaceable in a guide groove 11c, 11d in the area of the upper side of the guide profile 9c, 9d. The weight of the cassette housing 7c to 7e presses the respective slide web of the cantilever arm 10c to 10e into the guide groove 11d, affording a stable slide bearing for the cassette housing 7c to 7e. The guidance produced by the respective cantilever arm 10c to 10e, the associated slide web and the corresponding guide groove 11c to 11d is therefore arranged radially outside the cassette housing 7c to 7e, so that the opposing guides for the cassette housing 7c to 7e are at an interval from one another which is greater than the longitudinal extent of the respective cassette housing 7c to 7e, viewed in the vehicle transverse direction.

In other embodiments of the solution according to the invention, roller bearing guides are provided instead of slide guides. The arrangement and configuration of corresponding guides as slide or roller guides can also be designed in different ways according to the intended purpose.

In order to cover any remaining clearance gap between the lateral edges 14 of the protective canopy 4 to 4d and the corresponding guide profiles 9 to 9d in the embodiments described, and in order to be able to fix and/or tighten the protective canopy 4 to 4d, at least in its partially unwound and extended working state, a double-lip profile 8 to 8d, which is immovably held against the respective guide profile 9 to 9d, is assigned to each lateral area of the cassette housing 7 to 7e. The double-lip profile 8 to 8d is embodied as an open hollow elastomer profile, preferably as a rubber profile, and in profile has a cordate or spade-shaped contour. The term spade-shaped contour is taken to mean a bud-shaped contour with a cusp adjoining the bud to the rear, like the spades symbol in a deck of cards. The double-lip profile 8 to 8d is provided with an integrally formed fixing profile section 12 to 12d, which is held through positive interlock in a corresponding channel or hollow groove of the guide profile 9 to 9d. The fixing profile section 12 to 12d is preferably drawn in lengthwise from one face into the channel or hollow groove of the guide profile 9 to 9d. The double-lip profile 8 to 8d is therefore aligned transversely to the winding or unwinding direction of the protective canopy 4 to 4d inwards towards the middle of the vehicle. The double-lip profile 8 to 8d has two lip members 13 to 13d, which according to the embodiments shown overlap the assigned lateral edge 14 of protective canopy 4 to 4d on both sides. In profile, the two lip members are mirror symmetrical with one another about a horizontal center plane in which the protective canopy 4 to 4d is stretched, and in cross section each is convexly curved. At the same time, in the unstressed rest position they bear against one another with their free edge face areas. The two double lips 13 to 13d are of curved design such that in the resting state they are pressed against one another under pretension. As soon as a corresponding lateral edge 14 of the protective canopy 4 to 4d is located between the lip members 13 to 13d of the two opposing double profiles 8 to 8d, therefore, the corresponding lateral edge of the protective canopy 4 to 4d will be gripped by the pretensioning of the lip members 13 to 13d.

In addition the lip members 13 to 13d of the respective double lip profile 8 to 8d can be expanded far enough to allow a corresponding lateral area of the respective cassette housing 7 to 7d to penetrate between the lip members 13 to 13d, as can be seen from FIGS. 2, 6 and 7. The interval between the lip members 13 to 13d in direct proximity to the guide profile 9 to 9d and hence to the corresponding fixing profile section 12 to 12d is preferably so large that the corresponding lateral area of the cassette housing 7 to 7d is positioned with some play between the opposing inside walls of the lip members 13 to 13d. The lip members 13 to 13d therefore touch the surface of the cassette housing 7 to 7d only in a relatively narrow area, as can be seen from FIGS. 2 and 6. The narrow, preferably almost linear contact serves to reduce adhesion and sliding friction forces between the cassette housing and inside walls of the lip members. The expansion or spreading of the lip members 13 to 13d on a level with the lateral areas of the cassette housing 7 to 7d occurs exclusively in the elastic area, so that after a longitudinal displacement of the cassette housing 7 to 7d to another section of the guide, the lip members 13 to 13d close again, embracing and gripping the lateral edges 14 of the protective canopy 4 to 4d.

In order to allow a gentle expansion of the lip members 13 to 13d in the area of the cassette housing 7 to 7d, the cassette housing 7 to 7d in the area of its outer contour is tapered in the manner of a wedge in both directions of displacement, as can readily be seen from FIG. 7. The slow expansion is for one thing easy on the elastomer material of the lip members 13 to 13d. For another, the wedge-shaped design of the cassette housing 7 to 7d in both directions of the longitudinal extent of the protective device means that the lip members 13 to 13d are only forced apart immediately in front of the cassette housing 7 to 7d, so that under a corresponding longitudinal displacement of the cassette housing the lateral edges 14 of the protective canopy 4 to 4d remain gripped and thereby taut and fixed as long as possible.

The cassette housing 7e in FIG. 8 is likewise tapered to both sides in the manner of a wedge, so that in cross section a shell-like contour results. In this embodiment the cassette housing 7e comprises two housing shells G₁, G₂, which are approximately mirror symmetrical with one another and in the area of a seam, not further denoted, are joined together, preferably by means of lateral parts on opposite end faces of the housing. The exit slot 15 is provided between the two housing shells G₁, G₂.

FIG. 3 represents a similar cassette housing, the cassette housing 7a in FIG. 3 being embodied as a one-piece hollow profile.

The cassette housing 7b in FIG. 4 has a substantially hollow cylindrical profile and is likewise of one-piece design.

All embodiments as represented in the drawings and as previously described operate on the following principle: on initial use of the protective device 3 the free end face area of the protective canopy 4 is drawn out of the cassette housing and is immovably fixed between the guides. This fixing can either be achieved simply by gripping the end face area, at its opposite lateral edges, between the lip members of the double-lip profile, or alternatively by providing the end face area of the protective canopy with a dimensionally stable profiled strip or a similar retaining element, which is immovably anchored or otherwise fixed against corresponding functional parts of the opposing guides of the protective device. Since in all embodiments the width of the respective protective canopy is greater than the interval between the front edges of the opposing double lip profiles facing inwards towards the middle of the vehicle, the protective canopy with its lateral edges 14 is forcibly drawn in between the lip members of the double lip profiles when the canopy is drawn out of the cassette housing and is gripped by their elastic pre-tensioning. Regardless of how far the cassette housing is displaced in the guides, therefore, the flat area of the protective canopy drawn out at any given time is almost completely gripped between the double-lip profiles and is consequently held taut.

In especially preferred embodiments of the invention the lip members of the double-lip profiles are not only designed with a gripping function, as described above, but are additionally endowed with a tightening function in a transverse direction of the protective canopy and thereby transversely to the winding and unwinding direction. For this purpose the lip members have an elastic pretensioning component outwards in a transverse direction and hence away from the middle of the vehicle and the middle of the protective canopy. To achieve this tightening function, each lip member would in a notional, unstressed rest position not only protrude upwards and downwards over the respectively adjacent lip member, but would also additionally withdraw inwards towards the fixing profile section 12 to 12d. The lip member therefore has bending force components both in the direction of the adjacent lip member and in the direction of the fixing profile section located to the rear.

1. Protective device with a flexible protective canopy, having a winding shaft, on which the protective canopy is held so that it can be wound and unwound, and a mounting in which the winding shaft is rotatably supported, the mounting with its opposite lateral areas being guided so that it is longitudinally displaceable in immovable guides in the winding and unwinding direction of the protective canopy, and the protective canopy in the unwinding direction having a leading edge face which is immovably secured at least in a partially unwound state of the protective canopy, characterized in that over the displacement length of the mounting (7 to 7d), at least, the opposite lateral areas each have a flexible cover profile (8 to 8d) assigned to them, which immovably extends parallel to the guides (9 to 9d) and projects transversely to the direction of displacement towards the middle of the protective canopy (4 to 4d), in such a way that the cover profile (8 to 8d) at least partially covers a corresponding lateral edge (14) of the protective canopy (4 to 4d) and the corresponding lateral area of the mounting (7 to 7d).

2. Protective device according to claim 1, characterized in that clips (13 to 13d) for immovable fixing of the protective canopy (4 to 4d), which are of detachable design for an at least momentary release of the edge face (5) or the lateral edges (14), are assigned to the leading edge face (5) of the protective canopy (4 to 4d) and/or to the lateral edges (14) of the protective canopy (4 to 4d).

3. Protective device according to claim 2, characterized in that clips (13 to 13d) are spatially associated with the cover profile (8 to 8d).

4. Protective device according to claim 1, characterized in that at least one flexible cover profile is integrated in a double-lip profile (8 to 8d) in each case extending along an immovable guide (9 to 9d), the two lip members (13 to 13d) of which profile grip over the upper side and underside of the lateral area of the mounting (7 to 7e) and the associated lateral edge (14) of the protective canopy (4 to 4d), both lip members (13 to 13d) being of elastically pliable design.

5. Protective device according to claim 4, characterized in that the double-lip profile (8 to 8d) is embodied as a hollow elastomer profile, which besides the two lip members (13 to 13d) is provided with an integrally molded fixing profile (12 to 12d), which is immovably held.

6. Protective device according to claim 4, characterized in that the two lip members (13 to 13d) of the double-lip profile (8 to 8d) run parallel to the guide (9 to 9d) for the associated lateral area of the mounting (7 to 7e) and are elastically flexible, in such a way that they are capable of expanding around a housing section of the lateral area of the mounting (7 to 7e) and conform to the housing section, at least with linear contact.

7. Protective device according to claim 4, characterized in that the lip members (13 to 13d) are pressed against one another in an unstressed rest position, and with a lateral edge (14) of the protective canopy (4 to 4d) inserted between them exert a force closure on the lateral edge (14) such that a gripping action and in particular a restraining function is exerted on the lateral edge (14), countering any movement inwards transversely to the extending direction.

8. Protective device according to claim 1, characterized in that the mounting for the winding shaft comprises a housing (7 to 7e) into which the housing sections at the lateral areas are integrated and which, viewed in cross section, is tapered on both sides in the manner of a wedge.

9. Protective device according to claim 8, characterized in that the housing (7 to 7e)—viewed in cross section—is of convexly curved design both in the area of its upper side and in the area of its underside.

10. Protective device according to claim 9, characterized in that the housing (7e)—viewed in cross section—comprises two housing profile shells joined together.
